(19) United States
(12) Patent Application Publication
(10) Pub. No.: US 2020/0134651 A1
(43) Pub. Date: Apr. 30, 2020

(54) METHOD OF PROVIDING DISCOUNTED ITEMS TO AN INFLUENCER

(71) Applicant: GoVyrl, Inc., Irvine, CA (US)

(72) Inventors: David Perry, Irvine, CA (US); Jason Goldberg, Irvine, CA (US)

(21) Appl. No.: 16/177,138

(22) Filed: Oct. 31, 2018

(51) Int. Cl. G06Q 30/02

(52) U.S. Cl. CPC G06Q 30/0208; G06Q 30/0239; G06Q 30/0236

(57) ABSTRACT

In a method for providing discounts to influencers, a discount engine uses the credential information of an influencer to verify the identity of the influencer and access information relating to the followers of at least one of the influencer's social media accounts. The discount engine provides the influencer with a code to share with the followers to track purchases of one or more inventory items. Based on the purchases made by the followers using the code, the discount engine provides the influencer with a discount on an inventory items. The discount engine triggers provision of the inventory item to the influencer.

### FIELD OF THE INVENTION

The field of the invention is social media-based compensation systems.

### BACKGROUND

Given the dramatic increase in social media, there has been an accompanying increase in the number of individuals that influence diverse audiences by posting on social media outlets. These individuals have established a status in one or more social media communities that allows them to influence the decisions of their followers by, for example, passively or actively encouraging the purchase of a product or service.

Since influencers provide unique advertising value to a company and an associated brand, by effectively targeting specific demographics to improve conversion rates for particular products, companies have experimented with sending products to particular advertisers in an attempt to maximize the conversion rate of their products with higher efficiency than conventional advertisements. A problem arises, however, in that conventional influencer-based marketing models require significant guesswork is determining how effective a particular influencer might be at selling a good. Even if there is an increase in sales, these conventional models do not effectively isolate the variable(s) that led to a particular sale. As such, companies are left to guess which marketing outlets caused significant increases in sales.

Given the disadvantages of conventional influencer-based marketing models, there is a need to improve how influencers are chosen by accurately assessing which products an influencer can sell effectively, determining how well a particular influencer sold a particular product, and determining which new products to make available to an influencer for a reduced price or at no cost. Additionally, there is a need to offer a wide range of products at varying discounts depending on the influencer in order to motivate each influencer to purchase products that they sell effectively (i.e., giving influencers heavier discounts on products they sell well, such as shoes) while allowing the influencer the flexibility to select products based on their own preferences (i.e., allowing influencers to buy products at a lesser discount on products outside of their core markets).

U.S. Patent Application Pub. No. 2016/0314501 to Bartholomew discloses an influencer-based scoring system that gives credits to influencers based on sponsor bids. However, Bartholomew fails to contemplate a system that independently determines discounts for one or more influencer and/or follower transactions instead of relying on sponsorship bids. Additionally, Bartholomew contemplates earning credits to, in effect, pay for higher discount levels.

U.S. Patent Application Pub. No. 2014/0257921 to Bear discloses an approach for evaluating the commercial importance of a social media user. However, Bear fails to contemplate a system for dynamically providing discounts based on variety of social media specific variables, follower variables, and influencer variables. Further, Bear merely contemplates determining a commercial importance of an influencer and providing a discount code if the commercial importance of the influencer rises above a threshold. Bear fails to contemplate analyzing various sources of social media and sales data to determine a discount strategy particular to the influencer and particular to the followers.

Bartholomew, Bear, and all other extrinsic materials discussed herein are incorporated by reference to the same extent as if each individual extrinsic material was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for systems and methods that allow dynamically offer discounts to influencers based on their respective metrics and collect information to improve the efficacy of the systems and methods.

### SUMMARY OF THE INVENTION

Among other things, the inventive subject matter contemplates providing an inventory item to an influencer, based at least in part upon evaluation of effectiveness of the influencer in modifying purchasing behaviors of followers of the influencer. The method uses the credential information to verify identity of the influencer and access from at least one of the influencer's social media accounts, information relating to the followers. Once credential information is verified, the inventive subject matter provides the influencer with a code to share with the followers and a discount on at least one inventory item, wherein the discount is based at least in part on tracking of purchases made by the followers when using the code. Following a purchase by the influencer, the method triggers provision of the inventory item to the influencer.

Various resources, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a functional block diagram illustrating a distributed data processing environment.

FIG. 2 is a schematic of a method of determining a preliminary discount plan for one or more inventory items and providing the influencer with a code to track purchases tied to the influencer.

FIG. 3 is a schematic of a method of determining one or more inventory items to discount for an influencer and providing the influencer with personalized discounts.

FIG. 4 depicts a clock diagram of components of the server computer executing the discount engine within the distributed data processing environment of FIG. 1.

### DETAILED DESCRIPTION

It should be noted that while the following description is drawn to a computer-based scheduling system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As defined herein, it is contemplated that influencers can comprise any one or more of celebrities, social media influencers, content creators, and press/media entities. Any entity that actively or passively influences the purchasing behaviors of others can be considered an influencer. Additionally, subscribers to an influencer can include viewers, fans, followers, supporters, donors, and any entity that is exposed to the influence of an influencer.

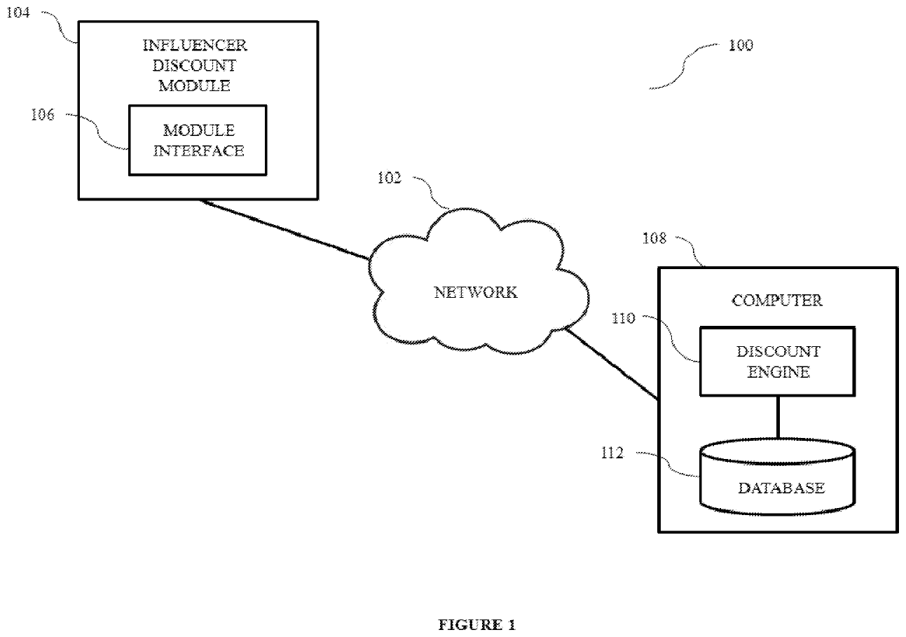

FIG. 1 is a functional block diagram illustrating a distributed data processing environment.

The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes influencer discount module 104 and server computer 108, interconnected over network 102. Network 102 can include, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between influencer discount module 104, server computer 108, and any other computing devices (not shown) within distributed data processing environment 100.

It is contemplated that influencer discount module 104 can be any programmable electronic computing device capable of communicating with various components and devices within distributed data processing environment 100, via network 102. It is further contemplated that influencer discount module 104 can execute machine readable program instructions and communicate with any devices capable of communication wirelessly and/or through a wired connection. For example, influencer discount module 104 can be any one or more of smart phones, desktop computers, tablet computers, laptops, and smart watches. It is contemplated that influencer discount module 104 also includes any one or more communicatively coupled peripheral electronic devices (e.g., computer mice, keyboards, electronic sensors, communication devices, storage devices, etc.). Influencer discount module 104 includes an instance of module interface 106.

Module interface 106 provides a user interface to discount engine 110. Preferably, module interface 106 comprises a graphical user interface (GUI) or a web user interface (WUI) that can display one or more of text, documents, web browser windows, user option, application interfaces, and operational instructions. It is also contemplated that user interface can include information, such as, for example, graphics, texts, and sounds that a program presents to a user and the control sequences that allow a user to control a program.

In some embodiments, user interface can be mobile application software. Mobile application software, or an “app,” is a computer program designed to run on smart phones, tablet computers, and any other mobile devices.

Module interface 106 allows a user to register with and configure discount engine 110 (discussed in more detail below) to enable discount engine to track purchases and determine user-specific discounts based on the characteristics of an item. It is contemplated that module interface 106 allows a user to provide any information to discount engine 110. For example, a user can input authentication, discount parameters, and any other information that is used by discount engine 110. As used herein, “discount parameters” comprise any variable(s) that can directly or indirectly control how discount engine 110 offers discounts to an influencer and/or followers of the influencer. For example, discount parameters can include special designations associated with items that the influencer likes to promote. In another example, discount parameters can be automatically set by discount engine 110.

Server computer 108 can be a standalone computing device, a management server, a web server, a mobile computing device, or any other computing system capable of receiving, sending, and processing data.

It is contemplated that server computer 108 can include a server computing system that utilizes multiple computers as a server system, such as, for example, a cloud computing system.

In other embodiments, server computer 108 can be a computer system utilizing clustered computers and components that act as a single pool of seamless resources when accessed within distributed data processing environment 100.

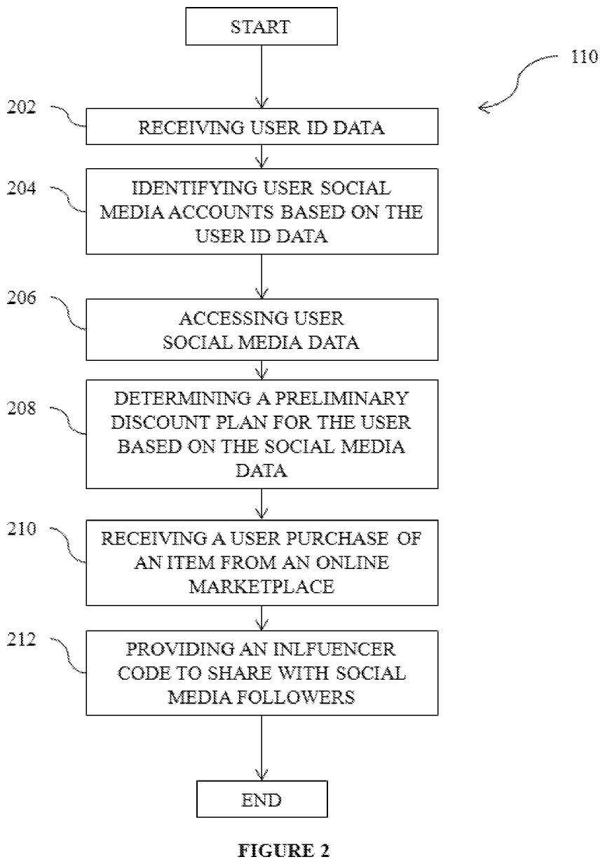

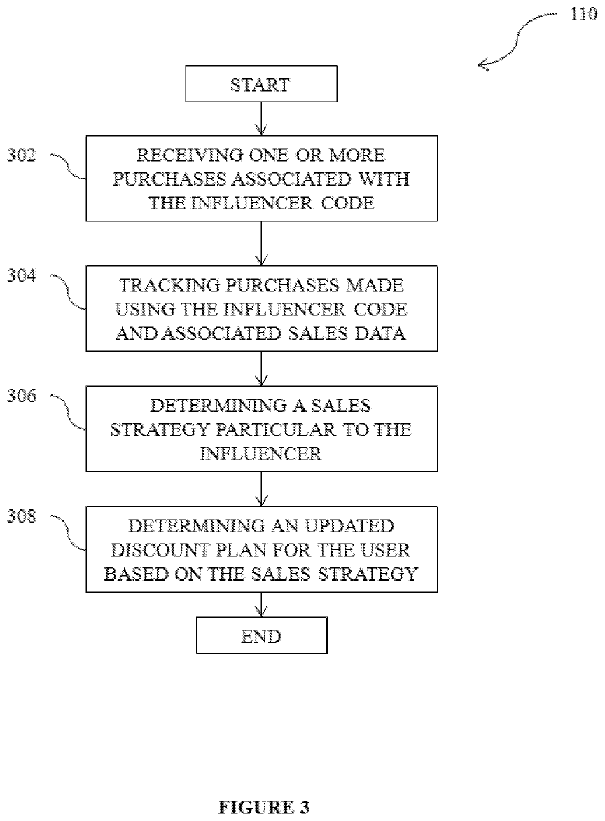

Discount engine 110 is depicted and described in more detail in FIG. 2 and FIG. 3.

Database 112 is a repository for data used by discount engine 110. In the depicted embodiment, discount engine 110 resides on server computer 108. However, database 112 can reside anywhere within a distributed data processing environment provided that discount engine 110 has access to database 112.

Data storage can be implemented with any type of data storage device capable of storing data and configuration files that can be accessed and utilized by server computer 108. Data storage devices can include, but are not limited to, database servers, hard disk drives, flash memory, and any combination thereof.

FIG. 2 is a schematic of a method of determining a preliminary discount plan for one or more inventory items and providing the influencer with a code to track purchases tied to the influencer.

Discount engine 110 authenticates a user based on user identification data (step 202).

As defined herein, user identification data refers to any identifying information indirectly and/or directly associated with a user. In some embodiments, it is contemplated that the user can access an influencer discount interface by selecting a user interface element associated with user interface 106. For example, a user can select an icon on a website that indicates that influencer discounts are available. As a result, the user can be presented with an interface that allows the user to submit user credential information for one or more social media platforms. Alternatively or additionally to the previous example, the user can select a user an icon on a user interface running on a physical computer in a retail location, which will present the user with an interface that allow the user to submit user credential information.

In one embodiment, user identification data can comprise an alphanumeric identification tag associated with a user and an accompanying password. For example, the user can input a user name and a password through module interface 106 to access the user's social media account, which allows discount engine 110 to access additional information associated with the user.

In another embodiment, user identification data comprises receiving, via a wired or wireless connection, authentication data associated with the user from a physical authentication device. For example, a user can carry a widget with a Radio-Frequency Identification (RFID) tag that wireless communicates electronically-stored information in the RFID tag to authenticate a user.

In yet another embodiment, user identification data can comprise biometric data associated with the user. For example, influencer discount module 104 can be a smart phone with a fingerprint reader that reads a user's fingerprints to authenticate the user. In another example, influencer discount module 104 can be a tablet computer with an eye scanner to scan a user's eye to authenticate the user. In a related embodiment, influencer discount module 104 can comprise a combination of sensors to recognize a user. For example, influencer discount module 104 can be a smart phone comprising an infrared camera, a flood illuminator, a proximity sensor, a dot projector, and a front camera to map the user's face to authenticate the user.

In situations where the user has logged in before, discount engine 110 can authenticate the identity of the user without any additional user input.

It is contemplated that authentication of a user based on user identification data can be achieved using any method, apparatus, and/or system in the art.

Discount engine 110 identifies social media accounts associated with the user based on the user identification data (step 204). It is contemplated that discount engine 110 can use the one or more user inputs received by influencer discount module 104 to identify social media accounts associated with the user.

In one embodiment, discount engine 110 can identify one or more social media accounts associated with the user based on inputted user credentials. For example, discount engine 110 can determine that there are four social media accounts linked to a user's email. Discount engine 110 can then prompt the user to input passwords for one or more of the linked social media accounts.

In another embodiment, discount engine 110 can receive biometric authentication associated with one or more social media accounts for a user. For example, a fingerprint scanner in a smart phone can determine that a social media account is linked to a user. Discount engine 110 can receive a scanned fingerprint to authenticate the identity of the user and access the user's social media data. In a related example, facial recognition devices and software associated with a smart phone can be used to authenticate the identity of the user that allow discount engine 110 to access the user's social media data. It is contemplated that any type of biometric information linked with an identity of the user can be used as a means of authentication.

Discount engine 110 accesses user social media data (step 206).

In one embodiment, user social media data can comprises any type of stored data associated with the user's social media account. For example, user social media data can include the number of followers a user has, the type of content the user submits, the timing of user social media submissions, and the number or comments on the user's posts.

In a related embodiment, it is also contemplated that user social media data can also comprise any type of data derived from the user's social media data. For example, user social media data can include identifiable trends associated with the user's social media activity. Identifiable trends can, for example, include a rate of increase or decrease in popularity of the social media account, rates of increase or decrease in followers, and types of submitted content that yields higher numbers of comments from other social media users.

In some embodiments, the user social media data can be used to perform a validity assessment to determine how legitimate the data is. For example, discount engine 110 can use natural language parsing and analyze the timing of posts to determine whether an influencer's followers are not bots. However, it is contemplated that social media data can be analyzed using any combination of methods available in the art (e.g., algorithms, subjective assessments, etc.).

Discount engine 110 analyzes the social media data (step 208).

Discount engine 110 can use primary or secondary data. In one embodiment, discount engine 110 analyzes primary data (i.e., unprocessed data collected directly from a source) to derive one or more conclusions about the primary data. For example, discount engine 110 can analyze how much time followers spent on average reading a post, how much the post was shared, and whether a follower posted a comment in response to the post.

It is contemplated that the one or more conclusions constitute secondary data, which can subsequently be processed to derive additional conclusions about the data. In a related embodiment, discount engine 110 can directly analyze secondary data or any other previously processed data. For example, sensor data can undergo preliminary processing to convert it into a form that can be used by discount engine 110.

Discount engine 110 can use any type of analysis available in the art. In one embodiment, discount engine 110 can use static algorithms that make data-driven predictions or decisions. For example, discount engine 110 can look at a total number of comments received on a user's social media posts for a particular platform over the course of a year and calculate an average number of comments per month.

In other embodiments, discount engine 110 can use non-static algorithms, including, for example, machine learning algorithms to make data-driven predictions. It is contemplated the non-static algorithms are configured to build a model from one or more sample or real-world inputs to modify the algorithm to better make data-driven predictions and/or decisions. For example, discount engine 110 can use natural language processing and image recognition software coupled to a supervised learning classifier to better identify and analyze the content of the user's social media submissions. Taking this example one step further, discount engine 110 can use a linear regression algorithm to analyze the relationship between the determined content of a user's social media submission and the number of comments the user is likely to receive.

In preferred embodiments, discount engine 110 can use any combination of static and non-static algorithms to make data driven predictions and/or decisions.

Discount engine 110 determines a preliminary discount plan for the user based on the social media data (step 210).

It is contemplated that discount engine 110 determines a preliminary discount plan for a user based on the results of one or more analyses. For example, discount engine 110 can predict that a user's social media submissions gain the most likes and comments when the user posts street wear and luxury goods. As a result, discount engine 110 can determine that clothing in the categories of street wear and luxury brands in participating online marketplaces will be discounted by 50% for the user and any clothing categories outside of the two categories will be charged at full price. Alternatively, discount engine 110 can determine that particular items in the categories of street wear and luxury brands in the online marketplace will be made available to the user for free, but the user will be limited to getting one item a month for free.

In some embodiments, discount engine 110 can implement a default discount plan for an influencer. In these embodiments, it is contemplated that discount engine 110 continues to analyze a user's social media data on an ongoing basis (e.g., continuously, periodically, etc.) to hone in on a discount plan that maximizes conversions of inventory items for one or more marketplaces, as discussed in more detail in FIG. 3.

Additionally, it is contemplated discount engine 110 can analyze a subscription and/or a unsubscription rate of followers associated with the influencer to determine how to change the discount plan for an influencer as their influence increases and decreases.

Discount engine 110 receives a purchase order from the user of an inventory item from an online marketplace (step 212).

In one embodiment, discount engine 110 receives a purchase order from an online marketplace. For example, the user can access a online marketplace having an influencer specific inventory selection that allows the user to purchase an inventory item for a discounted price. In another embodiment, discount engine 110 can receive a purchase order in a physical retail location. For example, a user can visit a store and input their social media log-in information. After verifying that the user is an influencer, discount engine 110 can present discounted prices for particular items to a user and receive the user's purchase order for one or more inventory items.

However, it is contemplated that discount engine 110 can receive a purchase order in any digital and/or physical retail environment.

Discount engine 110 provides an influencer with a code to share with social media followers (step 214).

It is contemplated that discount engine 110 can provide an influencer with any means of tracking the purchasing behaviors and associated data of followers. It is also contemplated that discount engine 110 can communicate with multiple influencers at scale, separately and/or simultaneously. For example, discount engine 110 can send a group of 1000 influencers a discount code for a brand based on the influencers' social media data.

In some embodiments, discount engine 110 serves as a communication hub and information database for multiple influencers. For example, discount engine 110 can group 1000 influencers together and allow the influencers to access data regarding commonly requested products, approved products, shipping data, and tracking data.

In other embodiments, discount engine 110 serves as a communication hub and information database allowing a brand to simultaneously or separately contact multiple influencers and data associated with each influencer. For example, discount engine 110 can group 1000 influencers together and allow a brand to access data regarding commonly requested products, approved products, shipping data, and tracking data. In a related example, discount engine 110 can allow a user to target the data of a particular group of influencers associated with street wear and analyze data associated with the targeted group. It is contemplated that discount engine 110 can allow a user to make quick decisions about a target group of influencers, including, for example, approving discounts, establishing discount levels, and sending notifications to the target group of influencers substantially simultaneously.

In one embodiment, the code is an alphanumeric code. For example, discount engine 110 can provide the influencer with an alphanumeric code that can be input by a follower during the checkout process at an online clothing store. The alphanumeric code can be used to track information about the purchasing behaviors of the followers, including, for example, successful conversion rate, products purchased, products added to online shopping cart, timing of purchases, number of purchases, average website browsing time, and any other trackable information about the followers.

In another embodiment, discount engine 110 automatically provides discounts to followers. For example, discount engine 110 can receive a follower's log in credentials for one or more social media accounts. Using on the social media accounts of the follower, discount engine 110 can determine that the follower spends the majority of time browsing and commenting on a particular influencer. Discount engine 110 can then offer influencer-specific discounts (e.g., shoe discounts for a high-profile sneaker influencer) to the follower either automatically or prompt the user to look at discounted items.

In yet another embodiment, discount engine 110 provides additional product options to a follower for particular products associated with an influencer. For example, discount engine 110 can add an extra color option exclusive to a particular influencer if a user is strongly associated with the particular influencer. In another example, discount engine 110 can add custom influencer branding options of particular products (e.g., autographed items, custom influencer logo on products, exclusive influencer-inspired color schemes, etc.).

FIG. 3 is a schematic of a method of determining one or more inventory items to discount for an influencer and providing the influencer with personalized discounts.

Discount engine 110 receives one or more purchase orders associated with the code shared by the influencer (step 302).

In one embodiment, discount engine 110 receives one or more purchase orders that are associated with a code that is manually input during a checkout process. For example, discount engine 110 can receive a purchase order where the purchaser inputs the code “INFLUENCER50” provided by the influencer to track purchases and provide a 50% discount on the purchase. In another example, discount engine 110 can receive a purchase order associated with an influencer provided code at a physical retail location.

In another embodiment, discount engine 110 can receive one or more purchase order associated with an influencer without requiring a code. For example, discount engine 110 can receive an order placed by a purchaser through a link provided on an influencer's social media page. When the purchaser uses the link to purchase an inventory item, the influencer's social media identity can be automatically linked to the identity of the influencer.

However, it is contemplated that the code discussed herein can be any means of tracking purchases of a purchaser and linking the purchases to one or more social media accounts of an influencer. For example, tracking can alternatively or additionally be executed by an urchin tracking module (UTM) without using a conventional discount code. In another embodiment, tracking can be achieved using a combination of methods that forgo the need for codes. For example, a combination of UTM links, cookies, social media logins, timing of posts, timing of reaction to posts, reference of sources, reference of sites, and tracked brand mentions can be collected and used to track purchasing behaviors of third parties associated with the influencer.

It is contemplated that discount engine 110 can use any methods known in the art to process any collected data. In a preferred embodiment, discount engine 110 uses match keys to isolate a targeted group of collected data based on one or more parameters. Match keys can incorporate specific rules/algorithms based on one or more variables associated with collected data. For example, a match key can comprise multiple input fields with each input field having a unique algorithm applied to it.

Match keys advantageously enable discount engine 110 to apply complex analytical processes to collected data records to produce highly tailored results. For example, discount engine 110 can use a match key to group user data records that fall within a specific set of purchasing behaviors (e.g., brand loyalty, frequency of purchases, subscriptions to influencer channels, etc.).

Discount engine 110 tracks purchases made using the code shared by the influencer and associated data (step 304).

It is contemplated that discount engine 110 can track purchases associated with an influencer from third parties in any manner known in the art. As discussed in step 302, discount engine 110 can directly track purchases. Additionally, discount engine 110 can, in preferred embodiments, track purchases associated with an influencer in substantially real time for all data permissions given. Data permissions can, for example, permit access to e-commerce sales data, retail sales data, geolocation data, credit card transaction data, brand social media account data, and brand communication system data (e.g., email, SMS text messages, etc.).

However, discount engine 110 can also directly track or derive additional data associated with purchases. In one embodiment, discount engine 110 can track the sales data associated with the followers of the purchaser. For example, discount engine 110 can track how many followers of a purchaser buy a particular product using either the code provided by the influencer or a separate code provided by the purchaser.

In another example, discount engine 110 can track which types of products from a brand's offerings are sold the most through an influencer. In this example, discount engine 110 can compare the influencer's sales performance to another influencer to determine how strongly the purchase choices of a follower are influenced by the influencer. As a result, for example, the data can suggest that an influencer is particularly good at selling shoes because the other influencers sell different categories of products from the same brand more effectively than shoes.

On the other hand, discount engine 110 can also determine that the influencer is no better at influencing purchases of particular products than other influencers, which can be, for example, a product of the general popularity of a good regardless of social media exposure.

In another embodiment, discount engine 110 tracks the social media activity that an influencer generates for a particular brand in social media platforms. For example, discount engine 110 can track the number of mentions of the brand name in the posts of followers. In a related example, discount engine 110 can track the number of pictures of a brand's product uploaded to social media using image recognition.

Discount engine 110 determines a discount strategy particular to the influencer (step 306).

It is contemplated that a discount strategy can be determined for the influencer in any manner known in the art.

In one embodiment, the discount strategy comprises a fixed discount scale. For example, discount engine 110 can determine that an influencer generates 1000+ sales in electronics, 500-999 sales in electronic accessories, and 0-499 sales in non-electronic goods in an average month. The fixed discount scale can provide a 75% discount in product categories with more than 1000 in number of average monthly sales, a 50% discount in products with 500-999 in number of average monthly sales, and no discount on average monthly sales numbers of less than 499. As a result, discount engine 110 can give the influencer a 75% discount on laptops, a 50% on external hard drives, and no discount on laptop bags.

In another embodiment, the discount strategy comprises a dynamic discount scale. For example, discount engine 110 can increase the percentage of discount for an influencer based on the rate of product sales. In a more specific example, discount engine 110 can increase the percentage of discount for a category of product 0.001% for every clothing sale made using the influencer's discount code. As the sales of products promoted by the influencer increase, the discount can continue to rise on the category of electronics for the influencer until it reaches 100% at 100,000 in sales.

Discount engine 110 can determine the categories of goods and service associated with categorical affiliations of the user. It is contemplated that discount engine 110 can use any means available in the art to determine the categories of particular goods and services. In one embodiment, discount engine 110 can determine the categories of goods using software to recognize images and/or text associated with a particular category. In other embodiments, the categories of products can be manually tagged by a person.

In yet another embodiment, discount engine 110 employs a machine learning algorithm to determine a discount strategy. For example, discount engine 110 can treat sales, product categories, and product characteristics as different variables in a machine learning algorithm. After acquiring more and more sales data over time, discount engine 110 can determine which combination of product categories and product characteristics most influence sales made by followers of an influencer. Based on the product categories and characteristics determined to be most influential in increasing sales, discount engine 110 can determine an influencer separately determined discount for every inventory item.

It is also contemplated that the discount strategy can be limited by one or more rules. For example, discount engine 110 can limit the influencer to 2 purchases a day at a 50% discount and 1 purchase a month at a 100% discount. In another example, discount engine 110 can limit the influencer to particular products in the categories (e.g., limiting discounts to products with greater than 40% profit margins per sale).

In alternative embodiment, discount engine 110 determines a discount strategy based on the social media activity of the influencer. For example, discount engine 110 can determine that an influencer that posts more than 5 posts a day and comments more than 15 times a day in at least two different social media platforms is considered a “highly engaged influencer,” which increases the discount given to at least one of the influencer or a follower.

Discount engine 110 determines an updated discount plan for the user based on the discount strategy (step 308).

It is additionally contemplated that discount engine 110 can use any of the methods discussed in step 306 and any method contemplated by the art to determine discounts for followers of an influencer.

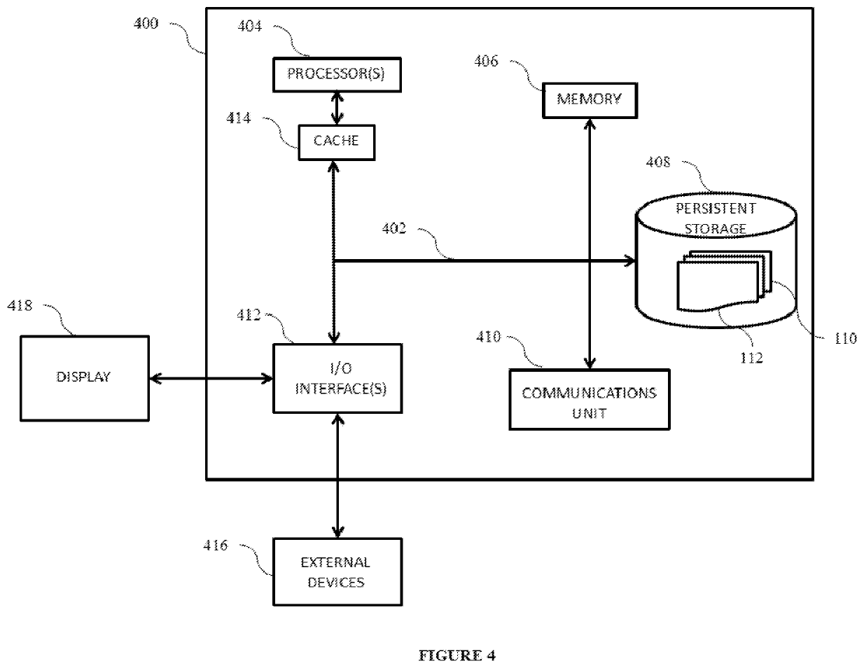

FIG. 4 depicts a block diagram of components of computer system 400 executing the program instructions associated with discount module 104 within the distributed data processing environment 100 of FIG. 1. FIG. 4 is not limited to the depicted embodiment. Any modification known in the art can be made to the depicted embodiment.

In one embodiment, the computer includes processor(s) 404, cache 414, memory 406, persistent storage 408, communications unit 410, input/output (I/O) interface(s) 412, and communications fabric 402.

Communications fabric 402 provides a communication medium between cache 414, memory 406, persistent storage 408, communications unit 410, and I/O interface 412. Communications fabric 402 can include any means of moving data and/or control information between computer processors, system memory, peripheral devices, and any other hardware components.

Memory 406 and persistent storage 408 are computer readable storage media. As depicted, memory 406 can include any volatile or non-volatile computer storage media. For example, volatile memory can include dynamic random access memory and/or static random access memory. In another example, non-volatile memory can include hard disk drives, solid state drives, semiconductor storage devices, a read-only memory (ROM), an erasable programmable read-only memory (EPROM), a flash memory, and any other storage medium that does not require a constant source of power to retain data.

In one embodiment, memory 406 and persistent storage 408 can be random access memory and a hard drive hardwired to influencer discount module 104, respectively. For example, influencer discount module 104 can be a computer executing the program instructions of discount engine 110 communicatively coupled to a solid state drive and DRAM.

In some embodiments, persistent storage 408 can be removable. For example, persistent storage 308 can be a thumb drive or a card with embedded integrated circuits.

Communications unit 410 provides a medium for communicating with other data processing systems or devices, including data resources used by influencer discount module 104. For example, communications unit 410 can comprise multiple network interface cards. In another example, communications unit 410 can comprise physical and/or wireless communication links.

It is contemplated that discount engine 110, database 112, and any other programs can be downloaded to persistent storage 408 using communications unit 410.

In a preferred embodiment, communications unit 410 comprises a global positioning satellite (GPS) device, a cellular data network communications device, and short to intermediate distance communications device (e.g., Bluetooth®, near-field communications, etc.). It is contemplated that communications unit 410 allows influencer discount module 104 to communicate with other compensation modules 104 associated with driverless and/or non-driverless cars in a vehicle priority system.

Display 418 is contemplated to provide a mechanism to display information from priority engine 110 through influencer discount module 104. In preferred embodiments, display 318 can have additional functionalities. For example, display 418 can be a pressure-based touch screen or a capacitive touch screen.

In yet other embodiments, display 418 can be any combination of sensory output devices, such as, for example, a speaker that communicates information to a user and/or a vibration/haptic feedback mechanism. For example, display 418 can be a combination of a touchscreen in the dashboard of a car, a car speaker system, and a vibrating bracelet worn by a user to communicate information through a series of vibrations.

It is contemplated that display 418 does not need to be physically hardwired components and can, instead, be a collection of different devices that cooperatively communicate information to a user.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something designated from the group consisting of A, B, C . . . and N, the text should be interpreted as requiring only one element from the group, not A plus N, or B plus N, etc.

1. A method of providing an inventory item to an influencer, based at least in part upon evaluation of effectiveness of the influencer in modifying purchasing behaviors of followers of the influencer, the method comprising:
verifying, by a computing system, an identity of the influencer using credential information of the influencer;
accessing, by the computing system, one or more social media accounts of the influencer using the credential information of the influencer, wherein accessing the one or more social media accounts includes accessing information relating to the followers of the influencer;
providing, by the computing system, the influencer with a code to share with the followers of the influencer on the one or more social media accounts of the influencer;
tracking, by the computing system, purchases made by the followers of the influencer using the code;
determining, by the computing system, a discount on the inventory item based on the purchases made by the followers of the influencer using the code, wherein the discount is based on a dynamic discount scale dependent on the purchases made by the followers of the influencer using the code;
providing, by the computing system, the influencer with the discount on the inventory item; and
triggering, by the computing system, provision of the inventory item to the influencer.

2. The method of claim 1, wherein the information relating to the followers is a number of subscribers to the influencer.

3. The method of claim 1, wherein the information relating to the followers is a number of submissions on a social media platform by an influencer.

4. The method of claim 1, wherein the information relating to the followers is at least one of a subscription rate and an unsubscription rate.

5. The method of claim 1, wherein the information relating to the followers is at least one or an average amount of time spent by a subscriber on a submission to a social media platform by the influencer.

6. The method of claim 1, wherein the information relating to the followers is sales data associated with the influencer.

7. The method of claim 1, wherein the information relating to the followers is an aesthetic theme associated with the influencer.

8. The method of claim 1, wherein the information relating to the followers is at least one of a categorical affiliation of the influencer.

9. The method of claim 1, wherein the information relating to the followers is an organizational affiliation of the influencer.

10. The method of claim 1, wherein the inventory item is branded with a mark of the influencer.

11. The method of claim 1, wherein the inventory item is not branded with a mark of the influencer.

12. The method of claim 1, wherein the discount is determined by a seller when the inventory item is sold.

13. The method of claim 1, wherein triggering provision of the inventory item to the influencer further comprises physical delivery of the inventory item to the influencer in a store.

14. The method of claim 1, wherein the discount is determined automatically when the inventory item is sold.

15. The method of claim 1, wherein the discount is limited by number of discounts provided to the influencer over a period of time.

16. The method of claim 1, wherein the discount is limited by total value of discounts provided to the influencer over a period of time.

17. The method of claim 1, wherein the discount is determined in part by a category of goods to which the inventory item belongs.

18. The method of claim 1, further comprising providing the influencer with monetary compensation based at least in part on the tracking of the purchases made by the followers when using the code.

19. The method of claim 19, wherein the compensation is at least one of access to privileged services and access to exclusive products.
